(19) United States
(12) Patent Application Publication
(10) Pub. No.: US 2014/0217294 A1
(43) Pub. Date: Aug. 7, 2014

(54) Method for Using LSO Background Radiation as a Transmission Source Using Time of Flight Information

(71) Applicant: Siemens Medical Solutions USA, Inc., Malvern, PA (US)

(72) Inventors: Harold E. Rothfuss, Knoxville, TN (US); Christian J. Michel, Lenoir City, TN (US); James J. Hamill, Knoxville, TN (US)

(73) Assignee: Siemens Medical Solutions USA, Inc., Malvern, PA (US)

(21) Appl. No.: 14/172,980

(22) Filed: Feb. 5, 2014

Related U.S. Application Data
(60) Provisional application No. 61/760,911, filed on Feb. 5, 2013.

(51) Int. Cl. G01T 1/29

(52) U.S. Cl. CPC G01T 1/2985
USPC 250/362; 250/363.03

(57) ABSTRACT

A method for using lutetium-based scintillator crystals' background beta decay emission in a positron emission tomography (PET) scanner as a transmission scan source for generating attenuation maps is disclosed.

### CROSS-REFERENCE TO RELATED APPLICATIONS

This application claims the benefit of U.S. Provisional Application No. 61/760,911 filed Feb. 5, 2013, the disclosure of which is incorporated herein by reference in its entirety.

### FIELD

The present disclosure generally relates to nuclear medicine, and systems for obtaining nuclear medicine images. In particular, the present disclosure relates to positron emission tomography (PET) utilizing lutetium-based scintillators and improvements thereof.

### BACKGROUND

The combination of PET imaging and x-ray computed tomography (CT) imaging in integrated PET/CT or PET-CT medical imaging systems provide more precisely aligning or correlating the functional imaging obtained by PET with anatomic imaging obtained by CT scanning. However, such integrated PET/CT medical imaging systems require the additional CT scanning hardware to be integrated with the PET imaging hardware. Thus, it would be useful if a transmission type scan data can be obtained using a PET scanner without the additional transmission scanning hardware such as a CT scanner.

General information about PET imaging may be found in U.S. Pat. No. 7,848,559 to Defrise et al. and U.S. Pat. No. 7,876,941 to Panin et al., both of which are incorporated herein by reference in their entirety.

### SUMMARY

The inventors hereby disclose a novel method for using lutetium-based scintillator crystals' background beta decay emission in a PET scanner, having lutetium-based scintillators, as a transmission scan source for generating attenuation maps in reconstruction of PET scan images.

According to an embodiment of the present disclosure, the method for using lutetium-based scintillator crystals' background beta decay emission in a PET scanner as a transmission scan source for generating attenuation maps comprises: (a) calculating a time-of-flight for a would-be beta emission with the coincidental cascade gamma emission from a Lu-176 beta decay based on the distance between two opposing detectors in the PET scanner's detector ring; (b) defining a time window having a width centered around the calculated time-of-flight; (c) measuring time-of-flight of actual beta emissions originating from Lu-176 beta decay in the lutetium-based scintillator crystals in the PET scanner with a scan object in the PET scanner's field of view; (d) comparing the measured time-of-flight from (c) against the calculated time-of-flight and identifying the measured time-of-flight that are within the time window; and (e) identifying the beta emissions events corresponding to those measured time-of-flight that are within the time window as transmission source events originating from the Lu-176 beta decay, thereby discriminating the transmission type data from Lu-176 beta decay as a transmission source from emission events and random events.

According to another aspect of the present disclosure, a PET scanner system is disclosed which comprises a detector ring comprising a plurality of lutetium-based scintillators; a machine-readable storage medium; a system controller connected to and in communication with said detector ring, wherein the machine-readable storage medium is encoded with a computer program code such that, when the computer program code is executed by the system controller, the system controller performs the method disclosed herein for using lutetium-based scintillator crystals' background beta decay emission in a PET scanner as a transmission scan source for generating attenuation maps.

According to another aspect of the present disclosure, a machine-readable storage medium is disclosed. The machine-readable storage medium tangibly embodies a program of instructions executable by a processor to perform the method disclosed herein for using lutetium-based scintillator crystals' background beta decay emission in a PET scanner as a transmission scan source for generating attenuation maps.

### BRIEF DESCRIPTION OF THE DRAWINGS

The following will be apparent from elements of the figures, which are provided for illustrative purposes and are not necessarily to scale.

FIG. 1 is a flowchart illustrating the disclosed method.

FIG. 2 is an illustration of a PET system.

FIG. 3 shows the decay scheme of Lu-176.

FIG. 4 a diagram showing the time bins 20 for the positron annihilation emission data and the new time bins 22 for the Lu-176 decay transmission data between two block detectors in 2 dimensions.

FIG. 5(a) shows CT attenuation map (the top row) and scaled attenuation map from Lu-176 transmission data (the bottom row) with 1 hour acquisition of a striatal brain phantom.

FIG. 5(b) shows a comparison of the profiles from both attenuation maps.

FIG. 6(a) shows a photograph of the experimental setup with hot uniform phantom and cold CT calibration phantom.

FIGS. 6(b)-6(d) show the corresponding sinograms.

FIG. 7(a) shows a profile across all the sinogram elements with summing over 100 angles and summing of all axial planes for 202 keV transmission sinogram.

FIG. 7(b) shows a profile across all the sinogram elements with summing over 100 angles and summing of all axial planes for 307 keV transmission sinograms.

FIG. 8 shows reconstructed transmission images of two human volunteers' heads with a carbon fiber head holder in the FOV.

FIG. 9 shows reconstructed transmission images of a human volunteer's torso.

FIG. 10 shows reconstructed transmission image of a larger human volunteer of weight of ˜180 kg that would experience truncation within the CT FOV.

FIG. 11(a) shows attenuation maps derived from CT (top left), 1 hour of Lu-176 transmission data (middle left) and 10 minutes of Lu-176 transmission data (bottom left).

FIG. 11(b) shows the PET emission reconstruction of 10 minutes of emission data from 4 mCi of F-18.

FIG. 12 shows attenuation maps derived from CT (top left) and from Lu-176 (bottom left). The images on right are PET emission data reconstructed with 10 minutes of emission data from ˜2 mCi of Ge-68.

FIG. 13 shows attenuation maps derived from CT (top left) and estimated with MLACF (bottom left). Right images are the corresponding PET emission reconstructions.

### DETAILED DESCRIPTION

PET emission data as collected in a traditional PET scan includes all information of the physical effects that emission photons undergo prior to detection in a detector. To reconstruct the collected emission data, corrections to the emission data are performed in order to reconstruct the true measured emission events. System corrections such as normalization, randoms and dead time corrections are independent of the object in the field of view (FOV) and are primarily dependent on the system and count rates of the activities that illuminate the PET detectors in and out of the FOV. Other corrections are object dependent such as the attenuation correction and scatter estimation and require attenuation information of the object's material in the scanner's FOV. This attenuation information is commonly collected separately from the PET emission acquisition using methods such as conducting separate CT transmission scans within the PET FOV or by a coupled modality as performed in the integrated PET/CT scans.

Such separate CT transmission scan is used in conventional PET scanner to generate an attenuation map that can be used to correct the attenuation effect in the emission PET scan data. Because of the lower photon energy of the CT x-rays (100-140 kVp), the CT attenuation coefficients are scaled to reflect the attenuation of the high-energy 511 keV emission photons first. Once scaled, they can be applied to the emission data to obtain the attenuation corrected image. The CT transmission scan is acquired followed by the emission PET scan.

The inventors have invented a novel method of utilizing the background radiation that exist in lutetium-based scintillators in the PET scanners as the transmission source to collect the attenuation information, thus eliminating the need for conducting separate CT transmission scans or using a coupled modality performed in integrated PET/CT scans. This simplifies the image reconstruction process in PET scanners using lutetium-based scintillators.

Lutetium-based scintillators have intrinsic background radiation which originates from the isotope Lu-176 that is present in natural occurring lutetium. The decay that occurs in this isotope is a beta decay that is in coincidence with cascade gamma emissions with energies of 307 keV, 202 keV, and 88 keV. The coincidental nature of the beta decay with the cascade gamma emissions allow for separation of the emission data originating from a positron annihilation event from transmission type data from the Lu-176 beta decay. By using the time-of-flight information and the information of the chord length between two lutetium-based scintillator pixels in coincidence as a result of Lu-176's beta decay emission and the emitted cascade gamma emission, a second time window can be set to observe the lutetium-based scintillator's background radiation as transmission events simultaneously with the primary gamma emission from the positron annihilation events in the subject's body during a PET scan.

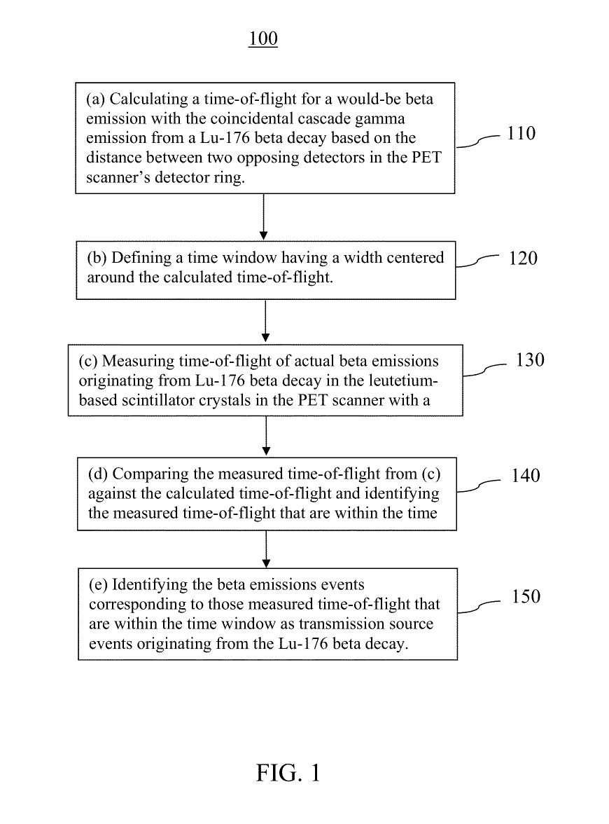

FIG. 1 is a flow chart 100 illustrating the method for using lutetium-based scintillator crystals' background beta decay emission in a PET scanner as a transmission scan source for generating attenuation maps is disclosed. The method comprises (a) calculating a time-of-flight for a would-be beta emission with the coincidental cascade gamma emission from a Lu-176 beta decay based on the distance between two opposing detectors in the PET scanner's detector ring. (See block 110). This step calculates what the time-of-flight should be for a beta emission with the coincidental cascade gamma emission from a Lu-176 beta decay in a given PET scanner based on the distance between two opposing detectors in the PET scanner's detector ring. In other words, the distance of interest here is the distance from the first detector, in which the beta emission occurs, to the second detector in which the coincidental cascade gamma is detected. Next, (b) a time window is defined, wherein the time window has a width centered around the calculated time-of-flight. (See block 120). Next, (c) time-of-flight of actual beta emissions originating from Lu-176 beta decay is measured in the lutetium-based scintillator crystals in the PET scanner with a scan object in the PET scanner's field of view. (See block 130). Next, (d) the measured time-of-flight from (c) are compared against the calculated time-of-flight and the measured time-of-flight that are within the time window are identified. (See block 140). Then, (e) the beta emissions events corresponding to those measured time-of-flight that are within the time window are identified as transmission source events originating from the Lu-176 beta decay, thereby discriminating the transmission type data from Lu-176 beta decay as a transmission source from emission events and random events (see block 150). The resulting transmission type data thus obtained can be used to generate attenuation maps for correcting the primary PET emission scan data.

The inventors have verified the method by implementing it on an example PET scanner, Siemens Biograph™ mCT scanner. This, however, required modifying the scan parameters for the Siemens Biograph™ mCT scanner because of the particular features of the Biograph™ mCT scanner. Mainly, the scan parameters of the scanner had to be modified to increase the coincidence window to result in a coincidence radius that is larger than the physical radius of the Siemens Biograph™ mCT scanner's detector ring. Multiple energy windows centered on 307 keV and 202 keV is then added to recognize the cascade gamma from Lu-176 decay.

A blank transmission scan data is acquired without any object in the PET scanner's field of view to provide a baseline transmission data. Subsequently, a PET emission scan is performed with the scan object in the field of view. During the scan, both the PET emission scan data and the discriminated transmission type data from Lu-176 beta decay are simultaneously acquired. The resulting transmission type data was then used to generate an attenuation map by reconstructing a transmission image from the transmission type data. PET emission scan data corrections are performed using the attenuation map, wherein the PET emission scan data corrections comprise at least one of attenuation correction and scatter correction.

The blank transmission scan refers to taking a transmission scan using the background radiation of Lu-176 with no object in the FOV. In order to avoid interfering with the measured PET scanning, the blank scan was conducted when the PET scanner was not being used and in an idle state. During the measured PET scanning, both the PET emission scan data and the discriminated transmission type scan data from Lu-176 beta decay were obtained. The blank transmission scan data and the measured transmission data of the object in the FOV were used to reconstruct a transmission image (i.e. a measured attenuation map). This reconstructed transmission image was then used to perform PET emission data corrections such as attenuation correction and scatter corrections. Inventors have observed that the flux of the background radiation activity is high enough to create good transmission images with an acquisition time of about 10 minutes.

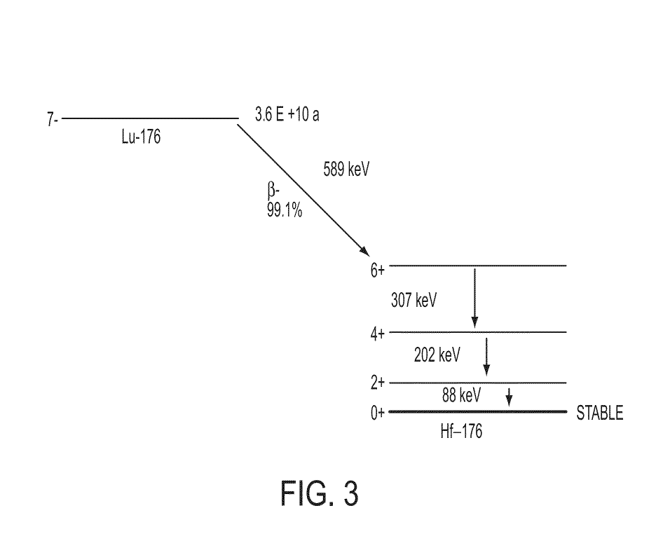

Lutetium-based scintillators are known to have intrinsic radiation that originates from the isotope Lu-176, which is 2.6% abundant in natural occurring lutetium. Lu-176 decay through beta decay with coincidental cascading gammas having energies of 307, 202 and 88 keV. This is illustrated in FIG. 3. In standard clinical lutetium scintillator based PET scanners, this intrinsic radiation is observed as singles events where enough energy from a beta emission or a beta plus a cascade gamma emission is deposited into a single block detector and qualified above the lower level discriminator. In Siemens Biograph™ mCT block detector used as an example, these singles rate was on the order of 5000 counts per second per block. This gives a 4 ring mCT a randoms rate of ˜1200 randoms per second.

In a standard Siemens Biograph™ mCT scanner, the coincidence signal from Lu-176 beta decay is not seen because the standard scan setting for the coincidence window on such mCT scanners is ˜4 ns which equates to a spatial acceptance radius of ˜30 cm. This prevents most of the longer lines of response (LOR) in the scanner from being considered. Because the spatial acceptance radius of ˜30 cm is smaller than the physical radius of the scanner (in the case of Siemens Biograph™ mCT, the physical radius is 43 cm) the Lu-176 decay emission emanating from the detector blocks are not seen. The physical radius of a scanner refers to the radius defined by the distance between two opposing detectors in the detector ring. The LORs that are less than the 30 cm in length are further discriminated by the lower level discriminator (LLD), which is set to 435 keV.

Therefore, in order to detect the decay emission radiation from Lu-176, some modifications were made to the Siemens Biograph™ mCT scanner's scan setting, but no modifications to the hardware was necessary. The coincidence time window was increased to an appropriate value to result in the coincidence radius that is larger than the physical radius of the scanner. In the example Siemens Biograph™ mCT scanner, increasing the coincidence window to ˜6.6 ns resulted in a coincidence radius of 49 cm compared to the physical radius of the scanner which is 43 cm. The LLD was lowered to ˜160 keV. The constant fraction discriminators (CFD) thresholds are also lowered to a value of 160 keV.

In the processing firmware for the detectors in the Siemens Biograph™ mCT scanner, multiple energy windows were added to discriminate between the original emission 511 keV photons (gamma) from a positron annihilation event and the two gammas from Lu-176. These additional energy windows were centered on 307 keV and 202 keV to recognize the cascade gammas from Lu-176. The events within these energy windows were tagged in listmode data and were used in the rebinner for energy discrimination.

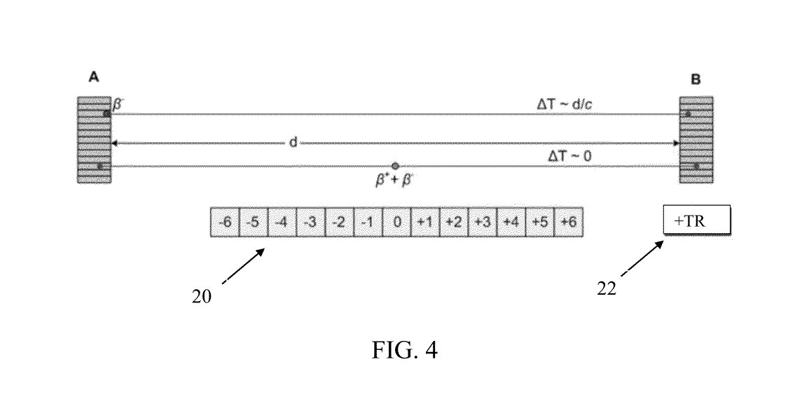

Then, the signal from Lu-176 was measured by recording the beta emanating from the originating detector as a source of a coincidence event, such as the origin of the decay so that the coincidences are directional based on the beta occurring first followed by the detection of the gamma at a later point in time. The signal from Lu-176 was then treated as a transmission type data. This beta ionizes its energy locally in the lutetium-based material and was accepted if it had enough energy to trigger the CFD. If one of the 307 keV or 202 keV gammas (the 88 keV gammas are ignored) escapes the originating detector, it traverses the FOV and be absorbed by an opposing detector and recorded as a coincidental event. The PET scanner then records the event's positions to create a LOR and records a time difference for the two events. By knowing the spatial positions of the two scintillator pixels that recorded the particular LOR, a look-up table can be created to relate the chord length of the measured LOR to the time of flight of the traversing gamma. The look up table is a table of distances between any two detector elements. Because a given PET scanner is a fixed geometry system, the look up table only has to be created once and is valid for all systems of the same geometry. Using this relation provided in the look-up table, a transmission coincidence time window was created for each LOR. FIG. 4 is a diagram showing the time bins 20 for the positron annihilation emission data and the new time bins 22 for the Lu-176 decay transmission type data between two block detectors in 2 dimensions. A event is the beta event and B is the gamma from a coincidental Lu-176 decay.

The events were further processed by knowing the energy of the gamma and using the information from the time-of-flight to get directionality of the LOR. Since the beta is emitted and captured locally in the LSO, the beta event happens first, therefore, in the detector element with the smaller time stamp of the two events. The beta only has to trigger the CFD whereas the gamma from Lu-176 decay must deposit enough energy to fall into one of the added energy window for the Lu-176 events.

The transmission data from Lu-176 decay obtained during the blank transmission scan were rebinned in the same manner as described above and also separated into 2 separate sinograms depending on the gamma's energy. Then, transmission images were reconstructed from this transmission data which was used as the attenuation maps for correcting the emission PET scan data. The transmission images were reconstructed with an ML-TR iterative algorithm with quadratic regularization that models the transmission data statistics.

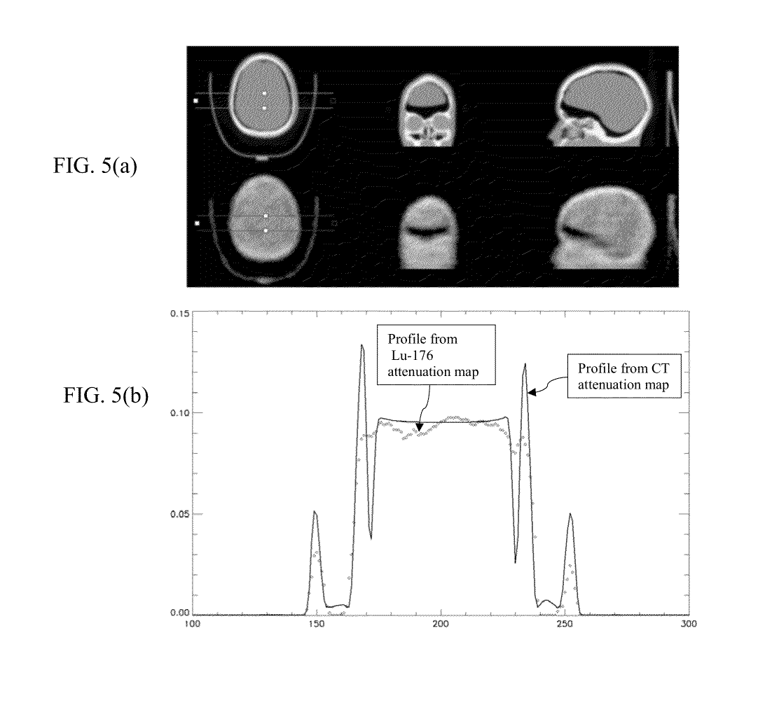

When using the attenuation maps from the Lu-176 transmission data for corrections to 511 keV emission data, scaling the raw attenuation map to 511 keV energies must be performed. For this work, when emission and transmission scan data were collected simultaneously, only the 307 keV transmission data was used. For this window, the attenuation values were scaled using the ratio of the total attenuation coefficients of water at the values of 511 keV and 307 keV, which is 0.096/0.117. The attenuation coefficients of water was used because the test phantom objects scanned were water-based or polymers that had very close attenuation characteristics of water. FIGS. 5(a), 5(b) demonstrate that the scaling of the reconstructed attenuation map from the transmission data from Lu-176 is similar to that derived from a CT scan. FIG. 5(a) shows CT attenuation map (the top row) and scaled attenuation map from Lu-176 transmission data (the bottom row) with 1 hour acquisition of a striatal brain phantom. FIG. 5(b) shows a comparison of the profiles from both attenuation maps. There is a loss of fine structure detail using the transmission method. How this translates into PET emission data corrections is discussed below.

### A. Rebinning of Emission and Transmission Data

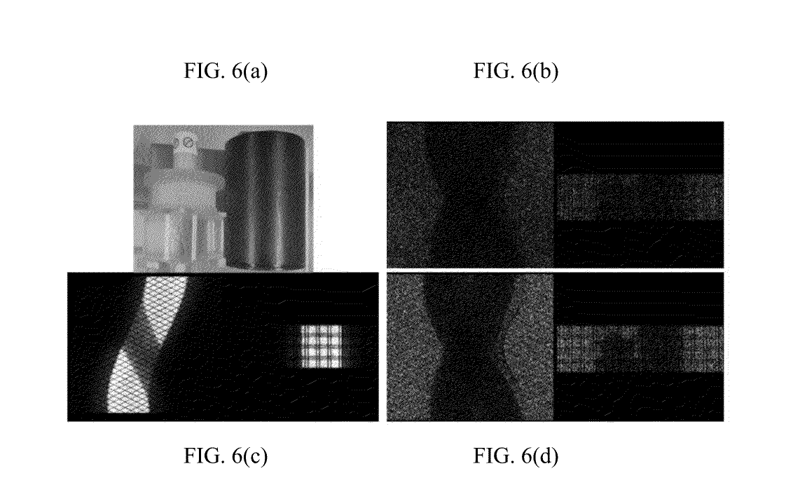

A phantom study was performed to demonstrate the ability to separate the emission and transmission data. A uniform phantom with ˜1 mCi of activity was placed on the bed next to a cold CT calibration phantom. FIGS. 6(b)-6(d) show the sinograms acquired simultaneously. FIG. 6(a) shows a photograph of the experimental setup with hot uniform phantom and cold CT calibration phantom. The corresponding sinograms are shown in FIGS. 6(b)-6(d). FIG. 6(c) shows the emission sinogram from a 10 minute scan acquisition and clearly shows the emission events with the shadowing of the cold CT phantom. FIG. 6(b) shows the transmission sinogram of 202 keV gammas from the 10 minute scan acquisition and FIG. 6(d) shows the transmission sinogram of 307 keV gammas from the 10 minute scan acquisition. In both transmission sinograms, both phantoms in the field of view are visible as well as the bed that the phantoms are placed on. All sinograms in the figures are displayed with the same polarity of greyscale.

### B. Contamination of Transmission Data from Emission Signal

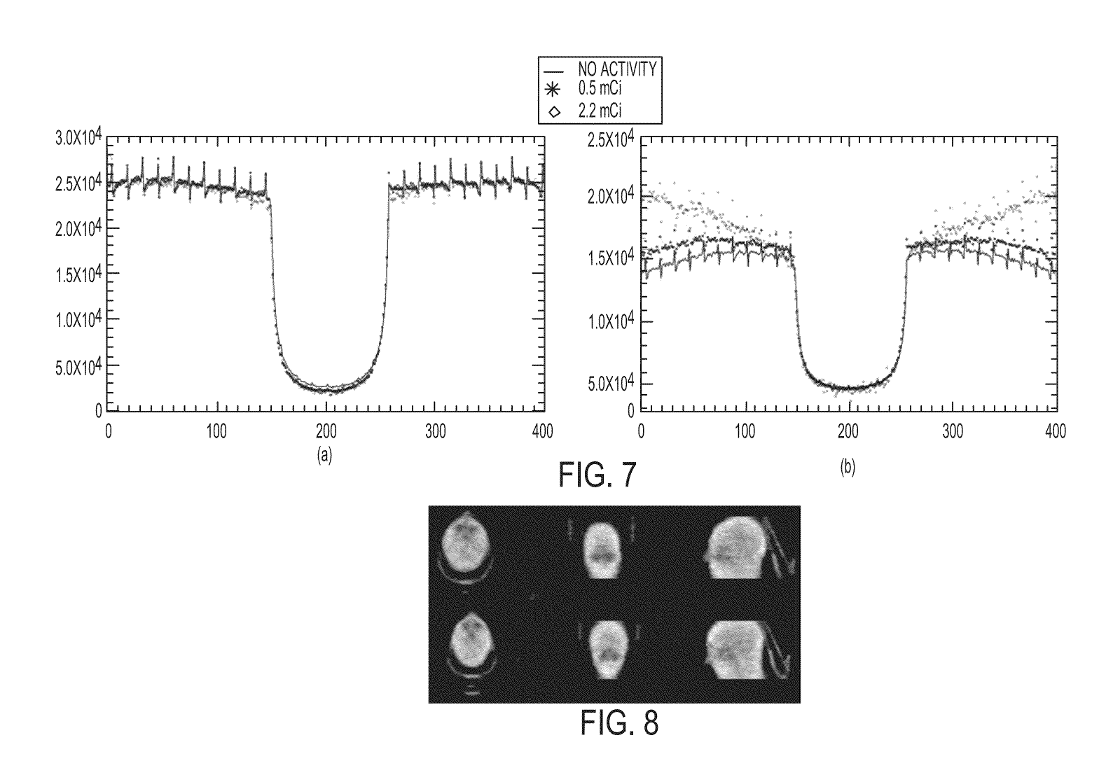

From FIGS. 6(b) and 6(d), one can observe a noisier 202 keV sinogram when compared to the 307 keV sinogram. A study was performed to see whether the transmission data was contaminated by the emission data and to determine whether the contamination is a function of emission source activity. Three uniform phantoms with varying activity from no activity to 0.5 mCi and 2.2 mCi were placed in the geometric center of the PET field of view. These phantoms were measured for 1 hour and rebinned into the 2 transmission trues sinograms (prompts—delays). A profile across all the sinogram elements with summing over 100 angles and summing of all axial planes are shown in FIGS. 7(a) for 202 keV and 7(b) for 307 keV transmission sinograms. No activity is shown with (a solid line “—”), 0.5 mCi is shown with (“*”), and 2.2 mCi is shown with (“ [symbol] ”).

There was some contamination in the 307 keV transmission data around the edge of the object which can be seen as a small mismatch between the profiles. The 202 keV transmission data has more visible contamination from emission data. The tails of the sinogram increases in events further away from the center of the field of view. This may be a result of when the backscattering angle approaches 90° and the energies are close to equal to each other and both events fall into the 202 keV window. The change of the profiles in the region outside the objects boundaries in the cold phantom when compared to the region outside the object in the 307 keV profiles could be a result of the 307 keV photons scattering in the object into the 202 keV energy window.

### C. Reconstructions of Cold Human Volunteers

A study of human subjects was performed in order to observe the quality of the images obtainable using this technique. The scan duration times were set to 10 minutes to simulate fairly realistic scan times and minimize movement from the study's volunteers. Each volunteer was placed on the PET scanner bed and inserted into the PET FOV with no activity in or around the PET scanner. A corresponding blank scan was acquired for 36 hours and used for reconstructions of the attenuation maps. The reconstruction algorithm parameters used were 10 iterations with 24 subsets with some regularization for all human volunteer studies. No corrections were performed to the data that corrects for object originating physical effects to the transmission gamma such as scatter or attenuation.

FIG. 8 shows reconstructed transmission images of two volunteers' heads with a carbon fiber head holder in the FOV. From the figure the sinus are visible and the head holder and outline of the head are well defined. Some high density regions are also visible such as parts of the skull and teeth.

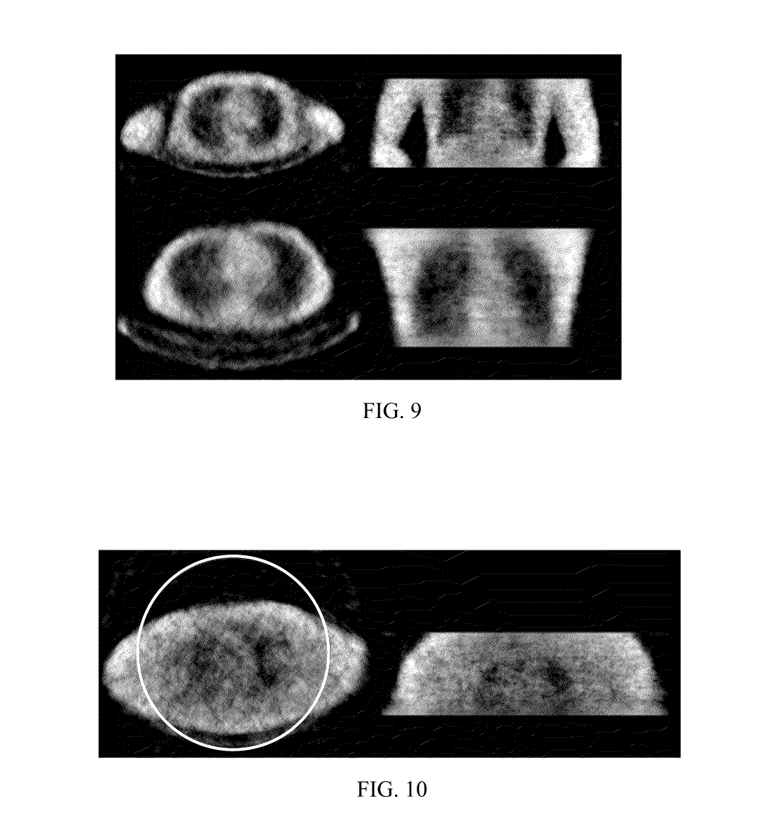

FIG. 9 shows reconstructed transmission images of a volunteer's torso. The volunteer was a male with weights of ˜70 kg. The study of the torso region was performed with both arms up (bottom images) and arms down (top images) in a relaxed position. Arms are usually up in a clinical scan and sometimes suffer from truncation of the CT. Using transmission data from Lu-176, the FOV for the attenuation maps are matched to the PET FOV. From both studies, body outline is clearly resolved and internal details such as lungs and the heart are visible. The two studies also differ as the arms down case had the volunteer laying directly on the carbon fiber bed and the arms up case had the volunteer laying on a foam mat between the body and the bed. The bed is easily seen in both images but only having the whole bed visible when the volunteer is lying on a foam mat that separates the body from the bed. The patient's arms up on the foam mat is the typical clinical procedure for imaging in the torso region.

FIG. 10 shows a larger human volunteer of weight of ˜180 kg who would experience truncation within the CT FOV. The circle illustrates the CT FOV. This study was performed with arms down and 10 minutes. The red circle illustrates the CT 50 cm FOV and shows even if this study was performed with arms extended overhead, truncation would still occur to this volunteer. It is observed that the body contour is still resolved and some internal structures are visible such as the lungs and heart, but not as clear as the smaller volunteers' case.

### D. Reconstruction of Emission Data with Lu-176 Attenuation Maps

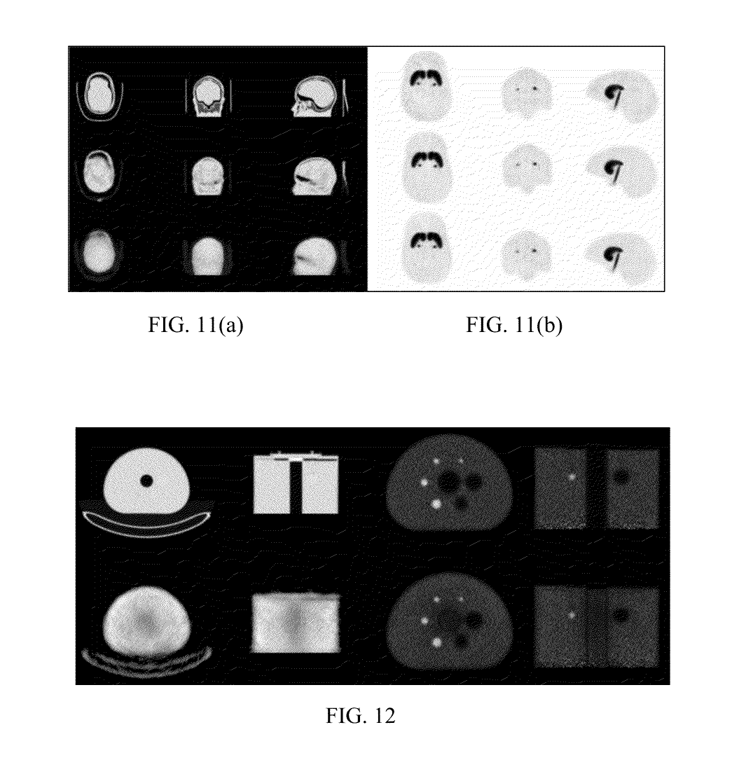

Work was performed to show the PET reconstructed images where the attenuation maps from the simultaneous transmission scan were used for the corrections to the PET emission data. The first case was a striatal head phantom with a fillable water cavity for addition of activity to the phantom. The phantom was filled with 4 mCi of F-18 and placed in a carbon fiber head holder. The phantom was scanned using a standard head-neck protocol for duration of 10 minutes. A corresponding CT was performed before the PET scan was acquired. The PET scan was the same for all three cases where the emission data was rebinned for 10 minutes into time of flight sinograms. FIG. 11 shows three cases of interest, CT corrected, 1 hour Lu-176 transmission, and 10 minutes of Lu-176 transmission data. The images in FIG. 11(a) show attenuation maps derived from CT (top left), 1 hour of Lu-176 transmission data (middle left) and 10 minutes of Lu-176 transmission data (bottom left). The images in FIG. 11(b) show the PET emission reconstruction of 10 minutes of emission data from 4 mCi of F-18 (image position correspond with attenuation maps used during corrections and reconstruction). The attenuation correction and scatter corrections were performed using the associated attenuation map and the PET emission reconstruction performed was OPOSEM with time of flight using 2 iterations and 24 subsets.

The PET emission data shows little difference between all three cases. Uniformity in all three cases also shows little differences demonstrating that the attenuation maps for these cases are good enough to perform the corrections to the emission data.

An image quality phantom was scanned to extend the study to a torso sized object. The phantom was filled with Ge-68 in an epoxy matrix and had an activity approximately 2 mCi at the time of the measurement. The phantom has 6 spheres with 4 hot (4× activity concentration from background) and 2 cold spheres with a cold cylinder in the center of the phantom. The phantom was placed in the centered to the bore and set on top of the bed in a foam holder for this particular phantom. A CT was performed before the phantom was moved into the PET FOV. The listmode acquisition was performed for 30 minutes. The emission data was rebinned for 10 minute acquisition time and all 30 minutes of transmission data for the 307 keV photons were rebinned for transmission data.

FIG. 12 shows the derived attenuation maps from the CT scan (top left) and from 30 minutes of transmission data from Lu-176 (bottom left). The images on the right are PET emission data reconstructed with 10 minutes of emission data from ˜2mCi of Ge-68. From the attenuation maps, it is observed that the cold cylinder in the Lu-176 transmission image is not well resolved. The corresponding PET emission images show some artifacts that come from having residual values in the cylinder that should be empty. This problem is not seen in the cold spheres because the spheres are all filled with epoxy. The cross talk between the emission data and the attenuation map puts activity in the region where there should be air and no activity.

### E. Reconstruction of Emission Data with Lu-176 Transmission Data and MLACF

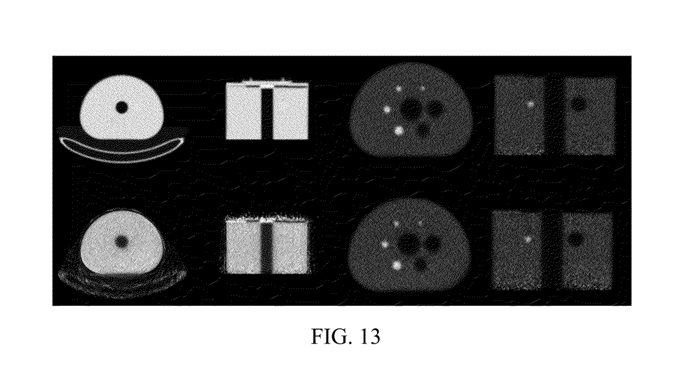

The attenuation maps created using the Lu-176 decays generally define the boundaries of the object being scanned fairly well. This information can help algorithms that estimate the attenuation and emission simultaneously such as MLACF. Using the Lu-176 attenuation maps, the scatter correction can also be performed on the object and the resulting scatter correction sinogram is inputted to the MLACF algorithm. The Lu-176 attenuation map can also be used as a starting image for the attenuation estimate of MLACF. The image quality phantom's data from the previous section was reconstructed using the MLACF algorithm with 5 iterations and 24. The resulting emission and attenuation maps are shown in FIG. 13.

The attenuation map shown in FIG. 13 is an estimate from MLACF and shows that the internal structures are well defined with respect to the attenuation map derived from just Lu-176 data (FIG. 11). There is some disadvantage to the MLACF attenuation map in that there is no estimation for the line of responses that have no emission data. The bed and the shell of the phantom are not recovered but do not seem to vary much from the starting image. The center hole is recovered and the emission reconstruction now has no emission contamination in the center cold region of the phantom as seen in FIG. 10. Although the images are similar, the comparison is challenging as the two emission images are reconstructed using different algorithms with different objective functions and convergence rates. A simple observation is that the uniform regions do appear uniform with no visible artifacts. The sphere recovery is similar between the two cases and the iterations were selected to try to achieve similar noise structure between the two cases.

The inventors have demonstrated that the Lu-176 decay that is already present in all lutetium-based PET scanners can be used as a transmission source. The technology that makes this work is the capability to measure time-of-flight of events detected by the PET scanner. With time-of-flight and some firmware modifications, simultaneous transmission and emission data can be collected.

It was shown that the transmission images acquired simultaneously could be used to assist the MLACF algorithms to produce PET emission images close to CT corrected PET emission images. The attenuation maps from Lu-176 events were also of enough quality to produce a scatter estimate that was necessary as an input for MLACF. Combining the two techniques yields a solution for PET imaging without the need of an external imaging modality to assist with the collection of attenuation information.

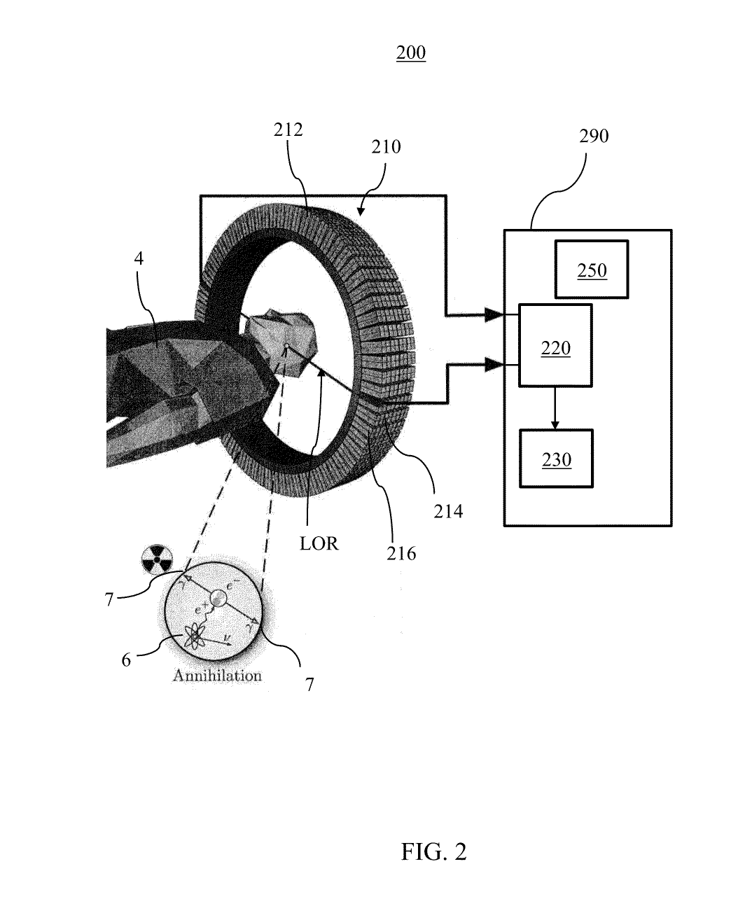

FIG. 2 shows an example of a PET scanner system 200 that utilizes lutetium-based scintillators that may implement the method disclosed herein. A human subject 4 for PET scanning is shown positioned inside a gantry 210 of the PET scanner system 200. The gantry 210 comprises a plurality of radiation detector rings 212, with each detector ring comprising multiple lutetium-based scintillator crystals 216 and the associated radiation detectors 214. When a PET scan is performed, a positron-emitting radioisotope 6 is introduced into the human subject 4 on a metabolically active molecule. When a positron encounters an electron, both are annihilated, yielding two gamma photons 7 that travel in approximately opposite directions. The annihilation events are identified by a time coincidence between the detection of the two gamma photons by two oppositely disposed detectors, i.e., the gamma photon emissions are detected virtually simultaneously by each detector. When two oppositely traveling gamma photons strike corresponding oppositely disposed detectors to produce a time coincidence event, the photons identify a line of response (LOR) along which the annihilation event has occurred.

Images of metabolic activity in the human subject 4 (nuclear medical images) are reconstructed by computer analysis. The PET scanner system 200 includes a system controller 290 connected to and in communication with the detector rings 212. The PET scanner system 200 further comprises a data processing unit (event detection unit) 220 which determines and evaluates coincidence events generated by the pair of gamma rays and forwards this information to an image processing unit (computational unit) 230. Detector pairs associated to each LOR produce many coincidence events during a measurement. The PET scanner system 200 further includes at least one machine-readable storage medium 250 that is encoded with a computer program code which when executed by the system controller 290, the system controller performs various operational functions of the PET scanner system 200.

According to an embodiment of the present disclosure, the machine-readable storage medium 250 of the PET scanner system 200 tangibly embodies a program of instructions (i.e. computer program code) executable by the system controller 290 such that when the program of instructions is executed by the system controller 290, the system controller performs the method disclosed herein for using lutetium-based scintillator crystals' 216 background beta decay emission in a PET scanner 200 as a transmission scan source for generating attenuation maps.

The embodiments and examples set forth herein are presented to best explain the present disclosure and its practical application and to thereby enable those skilled in the art to make and utilize the present disclosure. However, those skilled in the art will recognize that the foregoing description and examples have been presented for the purpose of illustration and example only. Thus, while preferred embodiments of the present disclosure have been described, it is to be understood that the embodiments described are illustrative only and that the scope of the invention is to be defined solely by the appended claims when accorded a full range of equivalence, many variations and modifications naturally occurring to those of skill in the art from a perusal hereof.

What is claimed is:

1. A method for using lutetium-based scintillator crystals' background beta decay emission in a positron emission tomography (PET) scanner as a transmission scan source (for generating attenuation maps), the method comprising:
(a) calculating a time-of-flight for a would-be beta emission with the coincidental cascade gamma emission from a Lu-176 beta decay based on the distance between two opposing detectors in the PET scanner's detector ring;
(b) defining a time window having a width centered around the calculated time-of-flight;
(c) measuring time-of-flight of actual beta emissions originating from Lu-176 beta decay in the lutetium-based scintillator crystals in the PET scanner with a scan object in the PET scanner's field of view;
(d) comparing the measured time-of-flight from (c) against the calculated time-of-flight and identifying the measured time-of-flight that are within the time window; and
(e) identifying the beta emissions events corresponding to those measured time-of-flight that are within the time window as transmission source events originating from the Lu-176 beta decay, thereby discriminating the transmission type data from Lu-176 beta decay as a transmission source from emission events and random events.

2. The method of claim 1, further comprising acquiring PET emission scan data the scan object in the PET scanner's field of view simultaneously with step (c); and generating attenuation maps from the transmission type data from Lu-176 beta decay for correcting the PET emission scan data.

3. A positron emission tomography (PET) scanner system comprising:
a plurality of detector rings comprising a plurality of lutetium-based scintillators;
a machine-readable storage medium; and
a system controller connected to and in communication with said detector rings, wherein the machine-readable storage medium is encoded with a computer program code such that, when the computer program code is executed by the system controller, the system controller performs a method for reconstructing a nuclear medical image from PET scan data obtained in a PET scanner using lutetium-based scintillators, the method comprising:
(a) calculating a time-of-flight for a would-be beta emission with the coincidental cascade gamma emission from a Lu-176 beta decay based on the distance between two opposing detectors in the PET scanner's detector ring;
(b) defining a time window having a width centered around the calculated time-of-flight;
(c) measuring time-of-flight of actual beta emissions originating from Lu-176 beta decay in the lutetium-based scintillator crystals in the PET scanner with a scan object in the PET scanner's field of view;
(d) comparing the measured time-of-flight from (c) against the calculated time-of-flight and identifying the measured time-of-flight that are within the time window; and
(e) identifying the beta emissions events corresponding to those measured time-of-flight that are within the time window as transmission source events originating from the Lu-176 beta decay, thereby discriminating the transmission type data from Lu-176 beta decay as a transmission source from emission events and random events.

4. The PET scanner system of claim 3, wherein said method further comprising acquiring PET emission scan data the scan object in the PET scanner's field of view simultaneously with step (c); and generating attenuation maps from the transmission type data from Lu-176 beta decay for correcting the PET emission scan data.

5. A machine-readable storage medium, tangibly embodying a program of instructions executable by a processor to perform method steps for reconstructing a nuclear medical image from positron emission tomography (PET) scan data obtained in a PET scanner using lutetium-based scintillators, the method comprising:
(a) calculating a time-of-flight for a would-be beta emission with the coincidental cascade gamma emission from a Lu-176 beta decay based on the distance between two opposing detectors in the PET scanner's detector ring;
(b) defining a time window having a width centered around the calculated time-of-flight;
(c) measuring time-of-flight of actual beta emissions originating from Lu-176 beta decay in the lutetium-based scintillator crystals in the PET scanner with a scan object in the PET scanner's field of view;
(d) comparing the measured time-of-flight from (c) against the calculated time-of-flight and identifying the measured time-of-flight that are within the time window; and
(e) identifying the beta emissions events corresponding to those measured time-of-flight that are within the time window as transmission source events originating from the Lu-176 beta decay, thereby discriminating the transmission type data from Lu-176 beta decay as a transmission source from emission events and random events.

6. The machine-readable storage medium of claim 5, wherein said method further comprising acquiring PET emission scan data the scan object in the PET scanner's field of view simultaneously with step (c); and generating attenuation maps from the transmission type data from Lu-176 beta decay for correcting the PET emission scan data.
